(19) United States
(12) Patent Application Publication
(10) Pub. No.: US 2009/0154662 A1
(43) Pub. Date: Jun. 18, 2009

(54) MULTIMEDIA TERMINAL ADAPTER AND A MESSAGE PROCESSING METHOD

(75) Inventor: YEH-HSI CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/187,400

(22) Filed: Aug. 7, 2008

(30) Foreign Application Priority Data
Dec. 13, 2007 (CN) 200710203040.6

(51) Int. Cl. H04M 1/64

(52) U.S. Cl. 379/88.11; 379/88.12

(57) ABSTRACT

A multimedia terminal adapter connected with a user telephone includes a message recording module, a first notifying module, a second notifying module, and a message playing module. The message recording module records a voice message of the user telephone. The first notifying module signals a displaying module to produce a first indication so as to visually notify a user of the voice message. The second notifying module signals the user telephone to ring so as to audibly notify the user of the incoming voice message. The message playing module plays the voice message when a request for playing the voice message has been received. A message processing method of the multimedia terminal adapter is also provided.

### BACKGROUND

1. Field of the Invention

Embodiments of the present disclosure relate to network communications and, more particularly, to a multimedia terminal adapter and a message processing method.

2. Description of Related Art

In a home application, users usually record their calls using a call recording device. The call recording device may be used for recording calls and playing recorded messages and may be placed between a multimedia terminal adapter and a telephone. In using such a device, users must pay for both the multimedia terminal adapter and the call recording device, which is not cost-effective.

Therefore, a heretofore unaddressed need exists in the home network to overcome the aforementioned deficiencies and inadequacies.

### SUMMARY

A multimedia terminal adapter, connected with a user telephone, including: a message recording module configured for recording an incoming voice message of the user telephone; a first notifying module configured for signaling a displaying module to produce a first indication so as to visually notify a user of the incoming voice message; a second notifying module configured for determining if the incoming voice message has been played within a predetermined interval of time when the user telephone is on-hook, and signaling the user telephone to ring so as to audibly notify the user of the incoming voice message if the incoming voice message has not been played within the predetermined interval of time; and a message playing module configured for playing the incoming voice message when a request for playing the voice message has been received.

Other advantages and novel features of the present invention will be drawn from the following detailed description, in which:

### BRIEF DESCRIPTION OF THE DRAWINGS

FIG. 1 is a schematic diagram of one embodiment of an application environment and functional modules of a multimedia terminal adapter in accordance with the present disclosure;

FIG. 2 is a flowchart of one embodiment of a message processing method in accordance with the present disclosure; and

FIG. 3 is a flowchart of the message processing method after node A of FIG. 2.

### DETAILED DESCRIPTION OF CERTAIN INVENTIVE EMBODIMENTS

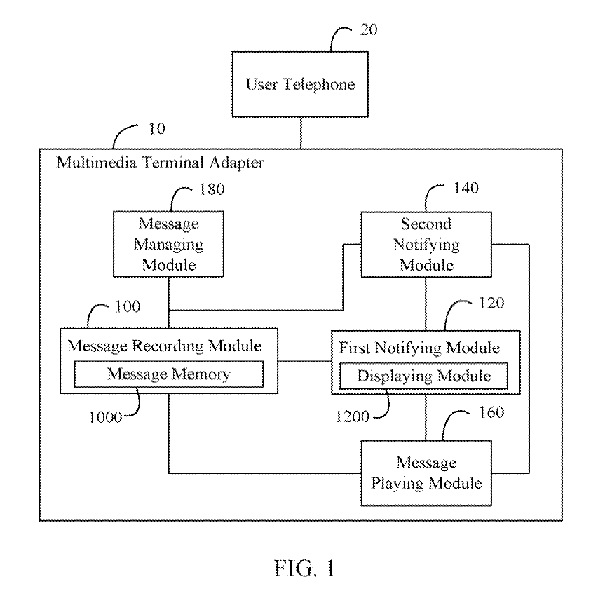

FIG. 1 is a schematic diagram of one embodiment of an application environment and functional modules of a multimedia terminal adapter 10 of the present disclosure.

In one embodiment, the multimedia terminal adapter 10 is connected to a user telephone 20. The multimedia terminal adapter 10 has the functionality of a common multimedia terminal adapter, such as data exchange between a telephone network and the Internet, and also has the functionality of call recording. In one embodiment, the multimedia terminal adapter 10 may be a Voice over Internet Protocol (VoIP) gateway, a cable modem, or an asymmetric digital subscriber line (ADSL) modem, among other adapters.

In one embodiment, the multimedia terminal adapter 10 includes a message recording module 100, a first notifying module 120, a second notifying module 140, and a message playing module 160.

The message recording module 100 is configured for recording an incoming voice message to the user telephone 20. In one embodiment, the message recording module 100 may automatically answer a call to the user telephone 20 when there is nobody to answer the call, and record a voice message received from the call. The message recording module 100 includes a message memory 1000 for recording a voice message from the call. The message memory 1000 may be a flash memory that is placed inside the multimedia terminal adapter 10 or a portable memory that is placed outside the multimedia terminal adapter 10. The multimedia terminal adaptor 10 communicates with the portable memory via a universal serial bus (USB) or another interface.

The first notifying module 120 includes a displaying module 1200 and is configured for driving the displaying module 1200 to produce a first indication to notify the user of an incoming voice message when the message recording module 100 has recorded an incoming voice message. In one embodiment, the first indication produced by the first displaying module 1200 is configured for visually notifying the user of the incoming voice message. The displaying module 1200 may be a light emitting diode (LED) placed on the multimedia terminal adapter 10. The first indication includes flashing of the LED of the displaying module 1200.

In another embodiment, the first indication may include another notifying mode. For example, the displaying module 1200 may be a liquid crystal display (LCD) that can produce the first indication to visually notify the user of the incoming voice message.

The first notifying module 120 is further configured for determining if the incoming voice message has been played when the user telephone 20 is on-hook. As used herein, the term, “on-hook” is a state that the user telephone 20 can receive an incoming call. Accordingly, the term, “off-hook” is a state of the user telephone 20 that allows dialing and transmission but prohibits incoming calls from being answered. The first notifying module 120 then continuously drives the displaying module 1200 to produce the first indication to notify the user of an incoming voice message if the incoming voice message has not been played. In one embodiment, the first notifying module 120 periodically determines if the incoming voice message has been played, which may be every five to ten minutes, in one embodiment.

The second notifying module 140 is configured for determining if the incoming voice message has been played within a predetermined interval of time when the user telephone 20 is on-hook. Accordingly, the second notifying module 140 may signal the user telephone 20 to ring if the incoming voice message has not been played. In one embodiment, the second notifying module 140 is configured for audibly notifying the user of the incoming voice message, in addition to the visual notification executed by the first notifying module 120. In one embodiment, the second notifying module 140 determines if the incoming voice message has been played within a predetermined interval of time, which may be every one to two hours, in one embodiment. In another embodiment of the present disclosure, the second notifying module 140 may notify the user of an incoming voice message via other notification signals or sounds, such as a beeping noise.

The message playing module 160 is configured for playing the incoming voice message when a request for playing the voice message has been received. In one embodiment, the request for playing the voice message includes a signal for detecting if the user telephone 20 is off-hook. In one example, the user will pick up the user telephone 20 to listen to the incoming voice message if the user receives a notification from the first notifying module 120 or the second notifying module 140. It may be appreciated that the user telephone may be off-hook in the previous example. The message playing module 160 determines if the off-hook signal from the user telephone 20 has been received when the user telephone 20 has been signaled to ring by the second notifying module 140. Subsequently, the message playing module 160 identifies the incoming voice message recorded by the message recording module 100 when the off-hook signal has been received and signals the user telephone 20 to play the incoming voice message. In another embodiment, the request for playing the voice message includes triggering a button on the multimedia terminal adapter 10. The message playing module 160 can also use a common playing module, such an internal or external audio device, to play the incoming voice message.

The first notifying module 120 is further configured for driving the displaying module 1200 to produce a second indication when the user telephone has completed playing all the incoming voice messages. In one embodiment, the second indication includes activating the LED of the displaying module to emit light continuously.

In another embodiment, the multimedia terminal adapter 10 further includes a message managing module 180 configured for managing the incoming voice messages recorded by the message recording module 100. In one embodiment, the incoming voice messages can be deleted, played, saved, or output through the message managing module 180.

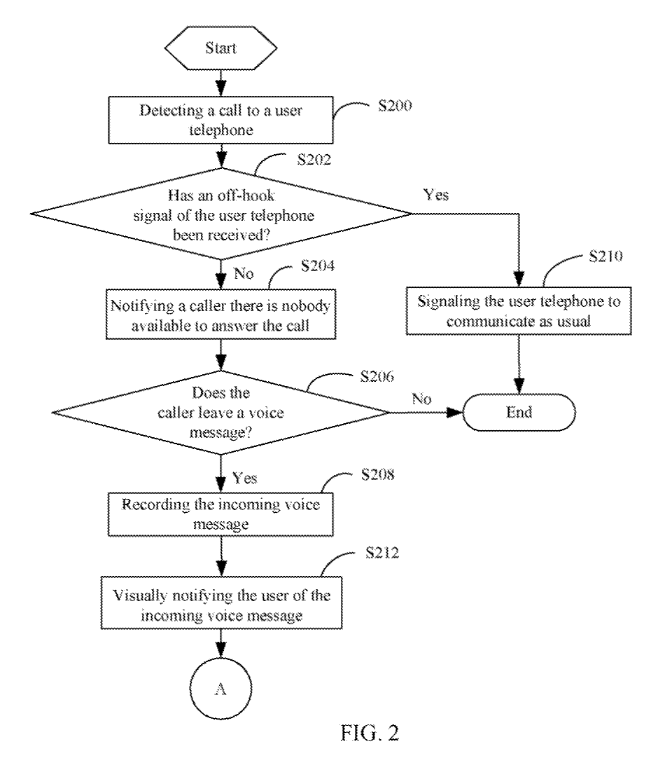

FIG. 2 is a flowchart of one embodiment of a message processing method in accordance with the present disclosure. In the embodiment of FIG. 2, the message processing method is performed via the functional modules of FIG. 1.

In block S200, the message recording module 100 detects if a call has been sent to the user telephone 20.

In block S202, the message recording module 100 determines if an off-hook signal from the user telephone 20 has been received. In one embodiment, the message recording module 100 determines if an off-hook signal from the user telephone 20 has been received within a predetermined time period after receiving an incoming call. The predetermined time period may be configured as the time period from when the user telephone 20 rings to when the user telephone 20 is off-hook, which may be 30 seconds, for example.

If the message recording module 100 does not receive an off-hook signal from the user telephone 20 within the predetermined time period in block S202, block S204 is executed, wherein the message recording module 100 notifies the incoming caller that there is nobody available to answer the call. In one embodiment, the message recording module 100 plays a message to notify the incoming caller that there is nobody available to answer the call, subsequently requesting the caller to leave a message.

In block S206, the message recording module 100 determines if the incoming caller wants to leave a voice message. In one embodiment, the message recording module 100 determines if the caller wants to leave a voice message by a triggering operation from the caller, such as when the caller presses a particular button or hangs up the user telephone 20.

If the caller wants to leave a voice message, then, in block S208, the message recording module 100 records the incoming voice message. In one embodiment, the message recording module 100 records the incoming voice message, compresses the incoming voice message to a voice file, and stores the voice file in the message memory 1000.

If the message recording module 100 determines the off-hook signal of the user telephone 20 has been detected within the predetermined time period, then in block S210, the multimedia terminal adapter 10 signals the user telephone 20 to communicate with the incoming caller as usual. The user telephone 20 is on-hook after the call.

The message recording module 100 records the incoming voice message from block 200 through block 208.

In block S212, the first notifying module 120 visually notifies a user of the incoming voice message. In one embodiment, the first notifying module 120 signals the displaying module 1200 to produce a first indication that includes flashing the LED continually.

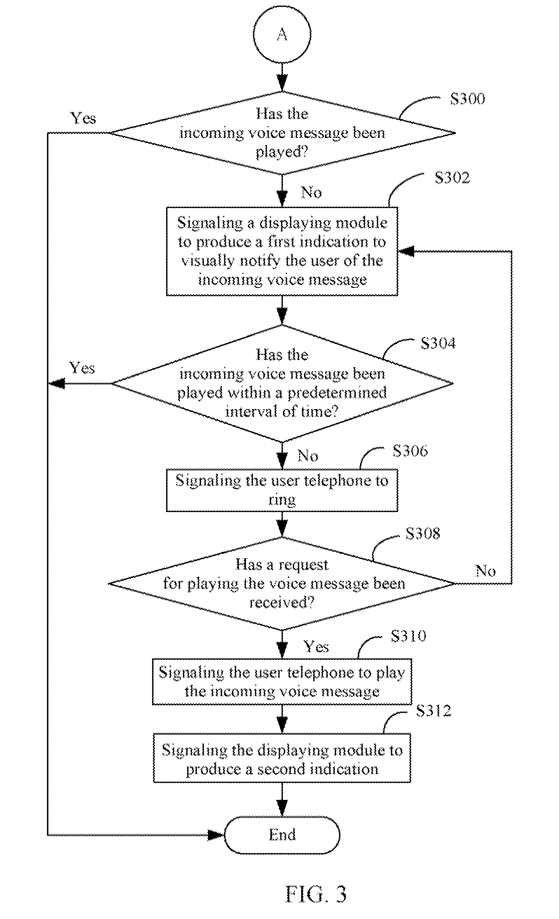

FIG. 3 is a flowchart of the message processing method after node A of FIG. 2.

In block S300, the first notifying module 120 determines if the incoming voice message has been played when the user telephone 20 is on-hook. In one embodiment, the first notifying module 120 periodically performs block S300, which may be every five to ten minutes, for example.

If the first notifying module 120 determines the incoming voice message has not been played when the user telephone 20 is on-hook, then in block S302, the first notifying module 120 continuously signals the displaying module 1200 to produce the first indication to visually notify the user of the incoming voice message.

In block S304, the second notifying module 140 determines if the incoming voice message has been played within predetermined intervals of time when the user telephone 20 is on-hook. In one embodiment, the second notifying module 140 performs block S304 within predetermined intervals of time, which may be one to two hours.

If the second notifying module 140 determines the incoming voice message has not been played within predetermined intervals of time, in block S306, the second notifying module 140 signals the user telephone 20 to ring. In one embodiment, the second notifying module 140 audibly notifies the user of the incoming voice message via ringing, in addition to the visual notification executed by the first notifying module 120.

In block S308, the message playing module 160 determines if a request for playing the voice message has been received. In one embodiment, the request for playing the voice message includes the off-hook signal from the user telephone 20. The message playing module 160 determines if the off-hook signal from the user telephone 20 has been detected when the user telephone 20 is signaled to ring by the second notifying module 140.

If the message playing module 160 determines that there is no request for playing the voice message, in block S302, the first notifying module 120 continuously signals the displaying module 1200 to produce the first indication to notify the user of the incoming voice message.

If the message playing module 160 receives a request for playing the voice message, in block S310, the message playing module 160 signals the user telephone 20 to play the incoming voice message.

When the user telephone 20 finishes playing all the incoming voice messages, in block S312, the first notifying module 120 signals the displaying module 1200 to produce a second indication. In one embodiment, the second indication includes activating the LED of the displaying module to emit light continuously.

The multimedia terminal adapter 10 in one embodiment of the present disclosure includes the function of message recording therein, thereby reducing the cost and complexity of the overall home network. Together with the first notifying module 120 and the second notifying module 140, the multimedia terminal adapter 10 also has the functionality of visually (such as the LED flashing continually) and audibly (such as the user telephone 20 ringing) notifying the user of incoming voice messages. It may be appreciated that visually and audibly notifying a user of the user telephone 20 is very convenient. In one example, deaf or blind people may use the user telephone to be notified of an incoming phone call.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. A multimedia terminal adapter, connected with a user telephone, comprising:
a message recording module configured for recording an incoming voice message of the user telephone;
a first notifying module configured for signaling a displaying module to produce a first indication so as to visually notify a user of the incoming voice message;
a second notifying module configured for determining if the incoming voice message has been played within a predetermined interval of time when the user telephone is on-hook, and signaling the user telephone to ring so as to audibly notify the user of the incoming voice message if the incoming voice message has not been played within the predetermined interval of time; and
a message playing module configured for playing the incoming voice message when a request for playing the voice message has been received.

2. The multimedia terminal adapter as claimed in claim 1, wherein the request for playing the voice message comprises an off-hook signal from the user telephone when the user telephone has been signaled to ring by the second notifying module.

3. The multimedia terminal adapter as claimed in claim 1, wherein the first notifying module is further configured for determining if the incoming voice message has been played when the user telephone is on-hook, and signaling a displaying module to produce a first indication to visually notify the user of the incoming voice message if the incoming voice message has not been played.

4. The multimedia terminal adapter as claimed in claim 3, wherein the first notifying module signals the displaying module to produce a second indication if the user telephone finishes playing all the incoming voice messages.

5. The multimedia terminal adapter as claimed in claim 4, wherein the displaying module comprises a light emitting diode (LED), the first indication comprises flashing of the LED of the displaying module, and the second indication comprises activating the LED of the displaying module to emit light continuously.

6. The multimedia terminal adapter as claimed in claim 1, further comprising a message managing module for deleting, playing, saving, or outputting the incoming voice message.

7. A message processing method of a multimedia terminal adapter connected with a user telephone comprising:
recording an incoming voice message of the user telephone;
signaling a displaying module to produce a first indication so as to visually notify a user of the incoming voice message;
determining if the incoming voice message has been played within a predetermined interval of time;
signaling the user telephone to ring so as to audibly notify the user of the incoming voice message if the incoming voice message has not been played within the predetermined interval of time;
determining if a request for playing the voice message has been received; and
signaling the user telephone to play the incoming voice message if the request for playing the voice message has been received.

8. The message processing method as claimed in claim 7, wherein the request for playing the voice message comprises an off-hook signal from the user telephone when the user telephone has been signaled to ring.

9. The message processing method as claimed in claim 7, further comprising:
determining if the incoming voice message has been played when the user telephone is on-hook; and
signaling the displaying module to produce the first indication so as to notify the user of the incoming voice message if the incoming voice message has not been played when the user telephone is on-hook.

10. The message processing method as claimed in claim 9, further comprising:
determining if the user telephone has finished playing all the incoming voice messages; and
signaling the displaying module to produce a second indication if the user telephone has finished playing all the incoming voice messages.

11. The message processing method as claimed in claim 10, wherein the displaying module comprises a light emitting diode (LED), the first indication comprises flashing of the LED of the displaying module, and the second indication comprises activating the LED of the displaying module to emit light continuously.

12. The message processing method as claimed in claim 7, wherein the block recording an incoming voice message of the user telephone comprises:
detecting a call to the user telephone;
determining if an off-hook signal of the user telephone has been received;
notifying an incoming caller of the call that there is nobody available to answer the call if there is no off-hook signal of the user telephone within a predetermined time period;
determining if the incoming caller wants to leave a voice message; and recording the incoming voice message if the caller wants to leave a voice message.
